(19) United States
(12) Patent Application Publication
(10) Pub. No.: US 2025/0315922 A1
(43) Pub. Date: Oct. 9, 2025

(54) SYSTEMS AND METHODS FOR IMAGE COMPOSITING VIA MACHINE LEARNING

(71) Applicant: YAHOO ASSETS LLC, New York, NY (US)

(72) Inventors: Bhavin JAWADE, Buffalo, NY (US); Amir ERFAN ESHRATIFAR, Buffalo, NY (US); Kapil THADANI, New York, NY (US); Paloma DE JUAN, New York, NY (US); Joao Vitor Baldini SOARES, New York, NY (US); Jack CULPEPPER, New York, NY (US)

(21) Appl. No.: 18/626,427

(22) Filed: Apr. 4, 2024

(51) Int. Cl. G06T 5/50; G06T 7/194; H04N 5/272

(52) U.S. Cl. CPC G06T 5/50; G06T 7/194; H04N 5/272; G06T 2207/20081; G06T 2207/20221

(57) ABSTRACT

In some implementations, the techniques described herein relate to a method including: (i) training, by a processor, a machine learning model to create composite images from background scenes and foreground objects, (ii) identifying, by the processor, a digital image file that comprises a background scene and an additional digital image file that comprises a foreground object, (iii) compositing, by the machine learning model executed by the processor, the digital image file that comprises the background scene and the additional digital image file that comprises the foreground object to produce a composite digital image file that comprises the foreground object and the background scene by performing at least one of a channel concatenation step and a reverse diffusion sampling step, and (iv) causing display, by the processor, of the composite image file that comprises the foreground object and the background scene.

### BACKGROUND

Various types of machine learning models are able to generate images. Users can easily generate images of different styles and subject matter based on text and/or image prompts. However, compositing images—that is, placing one or more objects from a first image into a background from a second image—remains a highly challenging problem. Different images may have different lighting conditions, perspectives, scales, depths of field, visual styles, color balances, and so on. The smallest detail out of place can easily reveal to a viewer that something is amiss. Compositing images by hand can be a tedious and time-consuming process, making automation in this field a useful innovation.

### BRIEF DESCRIPTION OF THE DRAWINGS

FIG. 1 is a block diagram illustrating a system for image compositing via machine learning according to some of the example embodiments.

FIG. 2 is a flow diagram illustrating a method for image compositing via machine learning according to some of the example embodiments.

FIG. 3 is a block diagram illustrating a method for image compositing via machine learning according to some of the example embodiments.

FIG. 4 is a block diagram illustrating a method for image compositing via machine learning according to some of the example embodiments.

FIG. 5 is a block diagram of a computing device according to some embodiments of the disclosure.

### DETAILED DESCRIPTION

The instant disclosure describes systems and methods for programmatically compositing multiple images via machine learning models. Various machine learning (ML) models are capable of generating and/or editing images. One example of such a model is a generative ML model. Generative ML models, often underpinned by Generative Adversarial Networks (GANs) or diffusion models as well as text-based transformer models, are trained on massive datasets of images and text prompts and can be used to generate images of various sizes and styles in response to text and/or image-based prompts. Generative ML models are typically composed of a neural network with many parameters (typically billions of weights or more). For example, a generative ML model may use a GAN to analyze training data and/or image inputs. In some implementations, a generative ML model may use multiple neural networks working in conjunction. In one implementation, a generative ML model may also be capable of editing images. Additionally, or alternatively, a different type of ML model may be trained to edit images (e.g., images generated by a GAN-based model) by compositing two or more images together.

The example embodiments herein describe methods, computer-readable media, device, and systems that create composite images from one or more foreground objects and a background scene via one or more ML models. In some implementations, the systems described herein may train an ML model to perform image compositing and/or create training data for an ML model. For example, the systems described herein may create a set of triplets that consist of a foreground object, a background scene, and a composite image that includes the foreground object and the background scene in order to train an ML model to create composite images.

In some aspects, the techniques described herein relate to a method including: training, by a processor, a machine learning model to create composite images from background scenes and foreground objects by providing the machine learning model with a plurality of sets of triplets each composed of a training background scene, a training foreground object, and a training composite image that combines the training background scene and the training foreground object; identifying, by the processor, a digital image file that includes a background scene and an additional digital image file that includes a foreground object; compositing, by the machine learning model executed by the processor, the digital image file that includes the background scene and the additional digital image file that includes the foreground object to produce a composite digital image file that includes the foreground object and the background scene by performing at least one of a channel concatenation step and a reverse diffusion sampling step; and causing display, by the processor, of the composite image file that includes the foreground object and the background scene.

In some aspects, the techniques described herein relate to a method, wherein identifying, by the processor, the digital image file and the additional digital image file includes receiving text instructions describing at least one of the foreground object and the background scene.

In some aspects, the techniques described herein relate to a method, further including generating, by the machine learning model, at least one of the digital image file and the additional digital image file in response to receiving the text instructions.

In some aspects, the techniques described herein relate to a method, wherein compositing, by the machine learning model executed by the processor, the digital image file and the additional digital image file by performing the channel concatenation step includes: adding the foreground object as at least one channel to an intermediate composite image; adding the background scene as at least one additional channel to the intermediate composite image; and performing channel concatenation with the intermediate composite image such that a result of the concatenation preserves information from the foreground object, the background scene, and the intermediate composite image.

In some aspects, the techniques described herein relate to a method, wherein compositing, by the machine learning model executed by the processor, the digital image file and the additional digital image file by performing the reverse diffusion sampling step includes encoding the foreground object into tokens and performing cross-attention on the tokens.

In some aspects, the techniques described herein relate to a method, wherein by providing the machine learning model with the plurality of sets of triplets includes generating the plurality of sets of triplets.

In some aspects, the techniques described herein relate to a method, further including generating the plurality of sets of triplets by: identifying an object in a training image; inpainting the training image to create an artificial background scene without the object; performing at least one transformation on the object; and storing the training image as the training composite image, the artificial background scene as the training background scene, and the transformed object as the training foreground object.

In some aspects, the techniques described herein relate to a method, further including generating the plurality of sets of triplets by compositing the training foreground object with the training background scene to create the training composite image via diffusion with classifier guidance that ensures that the training composite image contains a version of the training foreground object and a version of the training background scene.

In some aspects, the techniques described herein relate to a non-transitory computer-readable storage medium for tangibly storing computer program instructions capable of being executed by a computer processor, the computer program instructions defining steps of: training, by a processor, a machine learning model to create composite images from background scenes and foreground objects by providing the machine learning model with a plurality of sets of triplets each included of a training background scene, a training foreground object, and a training composite image that combines the training background scene and the training foreground object; identifying, by the processor, a digital image file that includes a background scene and an additional digital image file that includes a foreground object; compositing, by the machine learning model executed by the processor, the digital image file that includes the background scene and the additional digital image file that includes the foreground object to produce a composite digital image file that includes the foreground object and the background scene by performing at least one of a channel concatenation step and a reverse diffusion sampling step; and causing display, by the processor, of the composite image file that includes the foreground object and the background scene.

In some aspects, the techniques described herein relate to a non-transitory computer-readable storage medium, wherein identifying, by the processor, the digital image file and the additional digital image file includes receiving text instructions describing at least one of the foreground object and the background scene.

In some aspects, the techniques described herein relate to a non-transitory computer-readable storage medium, further including generating, by the machine learning model, at least one of the digital image file and the additional digital image file in response to receiving the text instructions.

In some aspects, the techniques described herein relate to a non-transitory computer-readable storage medium, wherein compositing, by the machine learning model executed by the processor, the digital image file and the additional digital image file by performing the channel concatenation step includes: adding the foreground object as at least one channel to an intermediate composite image; adding the background scene as at least one additional channel to the intermediate composite image; and performing channel concatenation with the intermediate composite image such that a result of the concatenation preserves information from the foreground object, the background scene, and the intermediate composite image.

In some aspects, the techniques described herein relate to a non-transitory computer-readable storage medium, wherein compositing, by the machine learning model executed by the processor, the digital image file and the additional digital image file by performing the reverse diffusion sampling step includes encoding the foreground object into tokens and performing cross-attention on the tokens.

In some aspects, the techniques described herein relate to a non-transitory computer-readable storage medium, wherein by providing the machine learning model with the plurality of sets of triplets includes generating the plurality of sets of triplets.

In some aspects, the techniques described herein relate to a non-transitory computer-readable storage medium, further including generating the plurality of sets of triplets by: identifying an object in a training image; inpainting the training image to create an artificial background scene without the object; performing at least one transformation on the object; and storing the training image as the training composite image, the artificial background scene as the training background scene, and the transformed object as the training foreground object.

In some aspects, the techniques described herein relate to a non-transitory computer-readable storage medium, further including generating the plurality of sets of triplets by compositing the training foreground object with the training background scene to create the training composite image via diffusion with classifier guidance that ensures that the training composite image contains a version of the training foreground object and a version of the training background scene.

In some aspects, the techniques described herein relate to a device including: a processor; and a storage medium for tangibly storing thereon logic for execution by the processor, the logic including instructions for: training, by the processor, a machine learning model to create composite images from background scenes and foreground objects by providing the machine learning model with a plurality of sets of triplets each included of a training background scene, a training foreground object, and a training composite image that combines the training background scene and the training foreground object; identifying, by the processor, a digital image file that includes a background scene and an additional digital image file that includes a foreground object; compositing, by the machine learning model executed by the processor, the digital image file that includes the background scene and the additional digital image file that includes the foreground object to produce a composite digital image file that includes the foreground object and the background scene by performing at least one of a channel concatenation step and a reverse diffusion sampling step; and causing display, by the processor, of the composite image file that includes the foreground object and the background scene.

In some aspects, the techniques described herein relate to a device, wherein identifying, by the processor, the digital image file and the additional digital image file includes receiving text instructions describing at least one of the foreground object and the background scene.

In some aspects, the techniques described herein relate to a device, further including generating, by the machine learning model, at least one of the digital image file and the additional digital image file in response to receiving the text instructions.

In some aspects, the techniques described herein relate to a device, wherein compositing, by the machine learning model executed by the processor, the digital image file and the additional digital image file by performing the channel concatenation step includes: adding the foreground object as at least one channel to an intermediate composite image; adding the background scene as at least one additional channel to the intermediate composite image; and performing channel concatenation with the intermediate composite image such that a result of the concatenation preserves information from the foreground object, the background scene, and the intermediate composite image.

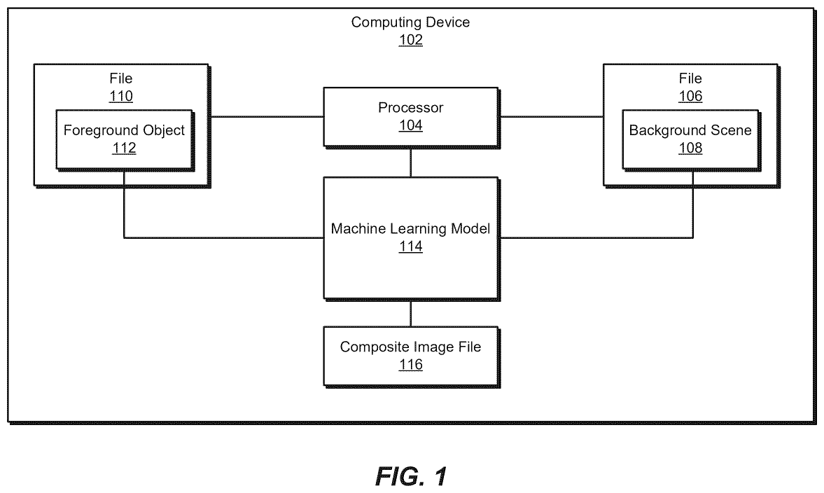

FIG. 1 is a block diagram illustrating a system for image compositing via machine learning according to some of the example embodiments.

The illustrated system includes a computing device 102. Computing device 102 may be configured with a processor 104 that trains a machine learning model 114 to create composite images from background scenes and foreground objects by providing machine learning model 114 with a plurality of sets of triplets each composed of a training background scene, a training foreground object, and a training composite image that combines the training background scene and the training foreground object. At some point in time, processor 104 may identify a digital image file 106 that includes a background scene 108 and an additional digital image file 110 that includes a foreground object 112. Next, machine learning model 114 may composite file 106 and file 110 to produce a composite image file 116 that includes foreground object 112 and background scene 108 by performing at least one of a channel concatenation step and a reverse diffusion sampling step. Immediately or at a later time, processor 104 may cause display of composite image file 116.

Although illustrated here on a single computing device 102, any or all of the systems described herein may be hosted by one or more servers and/or cloud-based processing resources. Additionally, or alternatively, any or all of the systems herein may be hosted on one or more client devices (e.g., endpoint devices such as laptops, desktops, smart devices, etc.). Further details of these components are described herein and in the following flow diagrams.

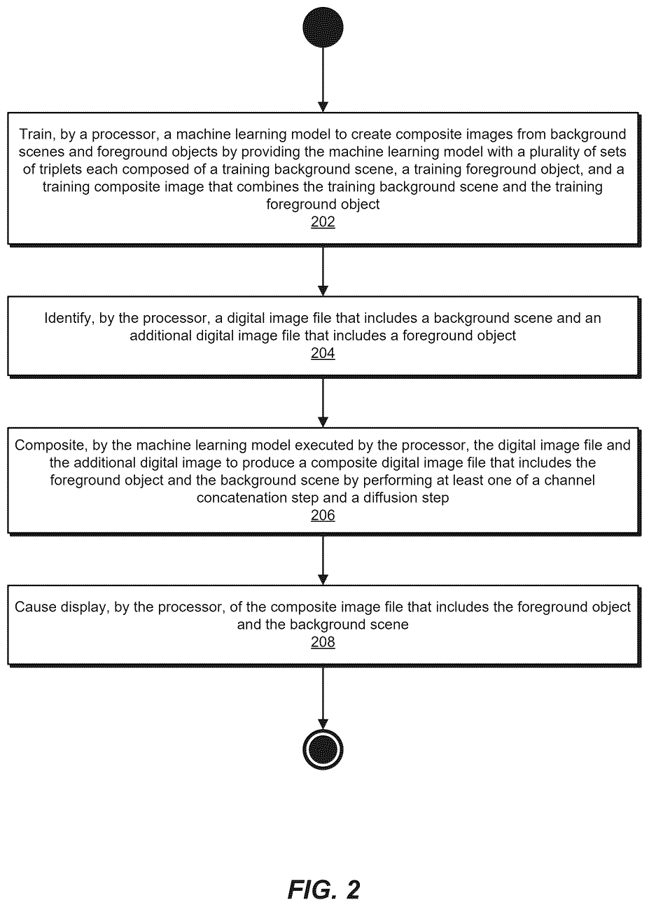

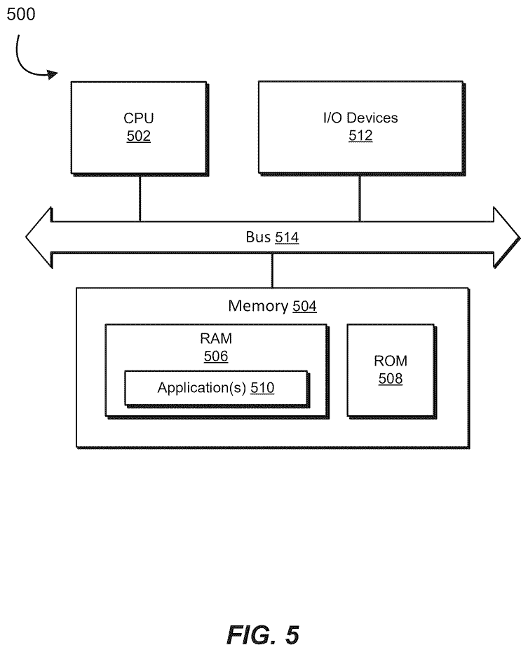

In the various implementations, computing device 102, processor 104, and/or ML model 114 can be implemented using various types of computing devices such as laptop/desktop devices, mobile devices, server computing devices, etc. Specific details of the components of such computer devices are provided in the description of FIG. 5 which are not repeated herein. In general, these devices can include a processor and a storage medium for tangibly storing thereon logic for execution by the processor. In some implementations, the logic can be stored on a non-transitory computer readable storage medium for tangibly storing computer program instructions. In some implementations, these instructions can implement some of all of the method described in FIG. 2.

In some implementations, files 106 and/or 110 can include digital image files of any type, size, and/or format. In one example, files 106 and/or 110 may be images generated by a generative ML model. Additionally, or alternatively, files 106 and/or 110 may be other types of images, such as photographs, digital paintings, vector images, and so forth. In some examples, file 106 and file 110 may be files of different origins and/or file types. For example, file 106 may be a photograph stored in MPEG format while file 110 may be a generated image stored in PNG format.

In one implementation, ML model 114 may include a GAN and/or other type of neural network. In some implementations, ML model 114 may include a diffusion-based ML model. In one implementation, ML model 114 may include a network of connected ML models. For example, ML model 114 may include an image encoding model and an image refinement model.

FIG. 2 is a flow diagram illustrating a method for image compositing via an ML according to some of the example embodiments.

In step 202, the method can include training, by a processor, an ML model to create composite images from background scenes and foreground objects by providing the ML model with a plurality of sets of triplets each composed of a training background scene, a training foreground object, and a training composite image that combines the training background scene and the training foreground object.

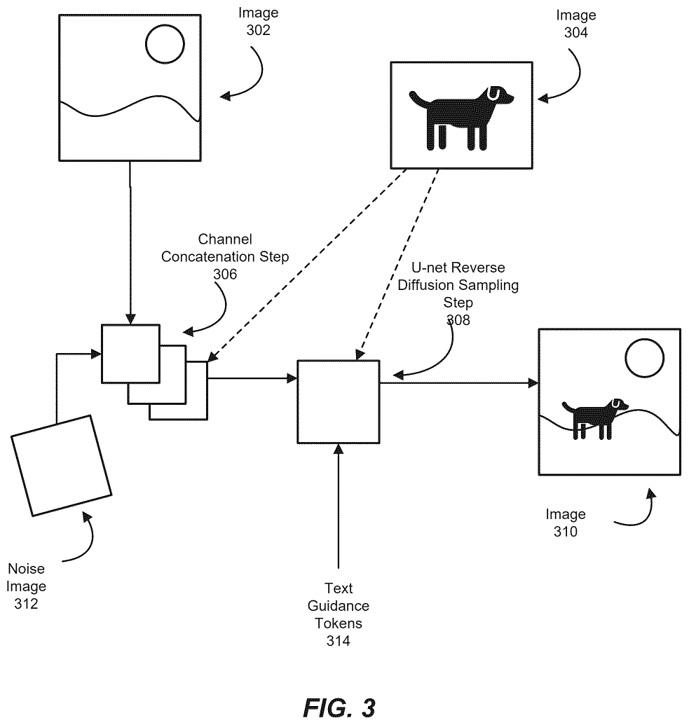

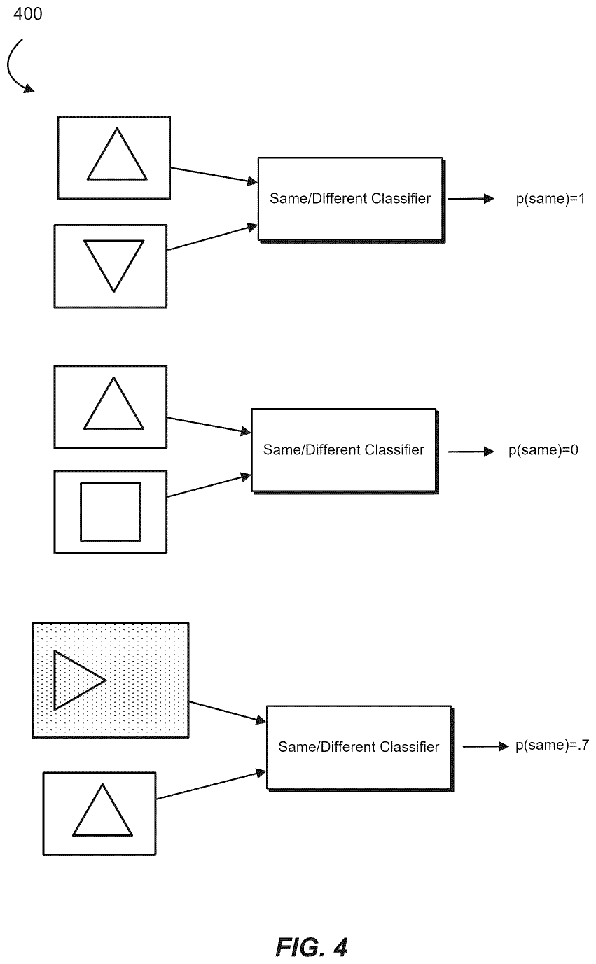

The systems described herein may train the ML model in a variety of ways, as will be described in further detail in conjunction with FIGS. 3 and 4.

In step 204, the method can include identifying, by the processor, a digital image file that includes a background scene and an additional digital image file that includes a foreground object.

In step 206, the method can include compositing, by the ML model executed by the processor, the digital image file and the additional digital image to produce a composite digital image file that includes the foreground object and the background scene by performing at least one of a channel concatenation step and a reverse diffusion sampling step.

The systems described herein may create the composite image file in a variety of ways. For example, the systems described herein may match the dimensions of the image file that includes the background scene. In some implementations, the systems described herein may paste the foreground object into the background scene at the location. In some examples, the systems described herein may perform one or more transformations on the background scene. For example, the systems described herein may add and/or remove shadows to the background scene to harmonize with the new foreground object, adjust the lighting conditions, and/or perform other suitable transformations. The systems described herein may perform a channel concatenation step and/or a reverse diffusion sampling step as described in greater detail in respect to FIG. 3.

In step 208, the method can include causing display, by the processor, of the composite image file that includes the foreground object and the background scene.

The systems described herein can cause the display of the composite image in a variety of ways. In one implementation, the systems described herein may be configured on a personal computing device and may display the image on a screen of the computing device. In another implementation, the systems described herein may be configured on a server and may transmit the image to an endpoint computing device for display. Additionally, or alternatively, the systems described herein may store the image to be used as training data for one or more ML models.

In one implementation, the systems described herein may train a compositing model. This model takes as input a background image, as well as a smaller image or cutout of a foreground object. It then outputs a new image, in which the foreground object is present within the background scene. In some implementations, the compositing model may be a diffusion model that is conditioned on an input image by concatenating extra channels to the inputs of the diffusion model. For image compositing, in order to input the background image along with the foreground object to be composited into the image, the systems described herein may add both the background and the object as extra channels via channel concatenation. Alternatively, the systems described herein may encode the foreground object into tokens and condition on the tokens via cross-attention.

For example, as illustrated in FIG. 3, the systems described herein may identify a background image 302 and a foreground image 304. The systems described herein may apply channel concatenation step 306 to background image 302 and either apply channel concatenation step 306 or u-net reverse diffusion sampling step 308 to foreground image 304 via cross-attention. The systems described herein may also apply channel concatenation step 306 to a noise image 312. In some implementations, noise image 312 can either be an image containing pure noise (e.g., at the beginning of the generation process) or can be a noisy version of the composite image that is being generated (e.g., with the noise decreasing as we take more steps). In some implementations, diffusion proceeds by gradually removing noise, step by step, until the image is completely or close to completely denoised at the final step. Generally, multiple denoising steps may be performed in sequence, where the output of one step is the input to the next. Accordingly, composite image 310 may either be a noisy version of the composite image (i.e., a intermediate noisy composite image) or the composite image itself (the latter only in the final denoising step when the method finishes). In some implementations, other inputs (302, 304, 314) can remain fixed throughout the process.

In some examples, the systems described herein may provide text guidance tokens 314 as input to u-net reverse diffusion sampling step 308. In one example, the systems described herein may output a composite image 310.

FIG. 3 depicts a single reverse diffusion sampling step, though in practice this step may be iterated multiple times in order to complete the whole reverse diffusion sampling process. This is done by applying the u-net repeatedly on the image being denoised. Note that the illustration in FIG. 3 is a simplification, as the u-net usually actually estimates the noise that should be subtracted from the noisy image, and not the denoised image itself. In some embodiments, the systems described herein may also receive input that encodes the time step and provide this as an extra input into the u-net.

The approach illustrated in FIG. 3 may allow for the output composite image to include several types of changes, such as in the pose or style of the foreground object, or addition of shadows and/or reflections in the background scene. Given this flexibility, the systems described herein may be configured to receive an optional extra input to the compositing model (in the form of some discrete label or text, aasuch as text guidance tokens 314) that controls which types of changes should be applied to the foreground object and background scene.

The flexibility of the approach comes from the great versatility of diffusion models and from the variety present in its training data. In some implementations, the ML model may be trained on training data where each training data example consists of triplets containing the input background image, the input foreground object image or cutout, and the desired composite output image. In some implementations, a cutout of an image may be defined based on the underlying image format. For example, for traditional raster image formats, a cutout could be encoded by using an image with an alpha channel (in addition to RGB), where the alpha indicates the opacity of each pixel, such that the background pixels would have zero alpha. As mentioned above, an optional additional input may be the label or text describing the class of changes allowed when doing compositing. This training data may be generated in multiple ways.

One way of generating training data is to use a model to learn the appearance of any particular foreground object (given one or more images of the object) and then to use either a text-prompt-based image editing technique or alternatively inpainting in order to place the object in the given background image. A single image of the foreground object could then be chosen randomly when forming the training triplets. In some implementations, as part of this process, the system can assign or learn unique identifiers and associate those unique identifiers with new objects or images. Then, this unique identifier can be used in a text prompt to generate a corresponding object or image.

Another approach to generating the training data uses diffusion with classifier guidance. The classifier guidance ensures that the generated image contains the foreground object, and also that it is very similar to the input background image. In order to generate training data for our model, the systems described herein can use classifier guidance to constrain the target output image. Classifier guidance consists of combining denoising reverse diffusion sampling steps with the gradient that results from some differentiable classifier. To ensure that the image generated by a diffusion model contains a given foreground object, the systems described herein can use a classifier that takes two images as inputs and tells us whether the two images contain the same object or not, a same/different classifier. The systems described herein may train this classifier with either real or synthetic data from an image generation model. FIG. 4 illustrates an example same/different classifier producing classification output based on different sets of input images. In some implementations, a diffusion model with classifier guidance can optionally be trained with images containing a particular object, as described above. In some implementations, in this approach the diffusion model can be prompted with a unique identifier for a learned object to improve the training process (i.e., speed, accuracy, etc.).

Once the same/different classifier is trained, the systems described herein may apply the classifier within a diffusion process with classifier guidance. In one case, the gradient of the same/different classifier may inform how the systems described herein change the intermediate composite image (being denoised with the reverse diffusion process) so that the output of the classifier moves toward “same.” In some implementations, the systems described herein may first detect where the object is or should be within the image being denoised, and then crop the image at that location, so that the same/different classifier is only applied within that focused region. The systems described herein may detect the object in the image being denoised by applying the same/different classifier at multiple scales and locations in a sliding window manner, and finding the scale and location with the largest probability/response for “same.” If the systems described herein implement the classifier as a convolutional network (CNN), there are efficient techniques that allow the model to quickly apply the classifier over the whole input image, though the systems described herein may still apply the classifier separately at multiple scales.

In order to use the standard approach to classifier guidance, the same/different classifier may be “noise-aware.” That is, the systems described herein may train the classifier with noisy images, so that the classifier may be applied to noisy intermediate images during the diffusion process.

Finally, in order to ensure that the generated image is similar to the input background image, the systems described herein can use a technique similar to classifier guidance. Here, instead of using the gradients of a classifier, the systems described herein can directly use the gradients of some simple differentiable loss function. In one example, this loss function could be the Euclidean distance between the features of the image being denoised and the features of the input background image:
Differentiable_loss=Euclidean_distance_between (
   features(image_being_denoised), features (input_background_image)
)

In one implementation, the systems described herein may compute the features ( ) above using a standard pre-trained feature extractor.

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 5, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
training, by a processor, a machine learning model to create composite images from background scenes and foreground objects by providing the machine learning model with a plurality of sets of triplets each comprised of a training background scene, a training foreground object, and a training composite image that combines the training background scene and the training foreground object;
identifying, by the processor, a digital image file that comprises a background scene and an additional digital image file that comprises a foreground object;
compositing, by the machine learning model executed by the processor, the digital image file that comprises the background scene and the additional digital image file that comprises the foreground object to produce a composite digital image file that comprises the foreground object and the background scene by performing at least one of a channel concatenation step and a reverse diffusion sampling step; and
causing display, by the processor, of the composite image file that comprises the foreground object and the background scene.

2. The method of claim 1, wherein identifying, by the processor, the digital image file and the additional digital image file comprises receiving text instructions describing at least one of the foreground object and the background scene.

3. The method of claim 2, further comprising generating, by the machine learning model, at least one of the digital image file and the additional digital image file in response to receiving the text instructions.

4. The method of claim 1, wherein compositing, by the machine learning model executed by the processor, the digital image file and the additional digital image file by performing the channel concatenation step comprises:
adding the foreground object as at least one channel to an intermediate composite image;
adding the background scene as at least one additional channel to the intermediate composite image; and
performing channel concatenation with the intermediate composite image such that a result of the concatenation preserves information from the foreground object, the background scene, and the intermediate composite image.

5. The method of claim 1, wherein compositing, by the machine learning model executed by the processor, the digital image file and the additional digital image file by performing the reverse diffusion sampling step comprises encoding the foreground object into tokens and performing cross-attention on the tokens.

6. The method of claim 1, wherein providing the machine learning model with the plurality of sets of triplets comprises generating the plurality of sets of triplets.

7. The method of claim 6, further comprising generating the plurality of sets of triplets by compositing the training foreground object with the training background scene to create the training composite image via diffusion with classifier guidance that ensures that the training composite image contains a version of the training foreground object and a version of the training background scene.

8. The method of claim 1, further comprising:
learning an appearance of a foreground object from one or more images; and
generating training triplets by one of adding the foreground object to a background scene using inpainting, or using a model with classifier guidance and a prompt corresponding to the learned object.

9. A non-transitory computer-readable storage medium for tangibly storing computer program instructions capable of being executed by a computer processor, the computer program instructions defining steps of:
training, by a processor, a machine learning model to create composite images from background scenes and foreground objects by providing the machine learning model with a plurality of sets of triplets each comprised of a training background scene, a training foreground object, and a training composite image that combines the training background scene and the training foreground object;
identifying, by the processor, a digital image file that comprises a background scene and an additional digital image file that comprises a foreground object;
compositing, by the machine learning model executed by the processor, the digital image file that comprises the background scene and the additional digital image file that comprises the foreground object to produce a composite digital image file that comprises the foreground object and the background scene by performing at least one of a channel concatenation step and a reverse diffusion sampling step; and
causing display, by the processor, of the composite image file that comprises the foreground object and the background scene.

10. The non-transitory computer-readable storage medium of claim 9, wherein identifying, by the processor, the digital image file and the additional digital image file comprises receiving text instructions describing at least one of the foreground object and the background scene.

11. The non-transitory computer-readable storage medium of claim 10, further comprising generating, by the machine learning model, at least one of the digital image file and the additional digital image file in response to receiving the text instructions.

12. The non-transitory computer-readable storage medium of claim 9, wherein compositing, by the machine learning model executed by the processor, the digital image file and the additional digital image file by performing the channel concatenation step comprises:
adding the foreground object as at least one channel to an intermediate composite image;
adding the background scene as at least one additional channel to the intermediate composite image; and
performing channel concatenation with the intermediate composite image such that a result of the concatenation preserves information from the foreground object, the background scene, and the intermediate composite image.

13. The non-transitory computer-readable storage medium of claim 9, wherein compositing, by the machine learning model executed by the processor, the digital image file and the additional digital image file by performing the reverse diffusion sampling step comprises encoding the foreground object into tokens and performing cross-attention on the tokens.

14. The non-transitory computer-readable storage medium of claim 9, wherein providing the machine learning model with the plurality of sets of triplets comprises generating the plurality of sets of triplets.

15. The non-transitory computer-readable storage medium of claim 14, the steps further comprising:
learning an appearance of a foreground object from one or more images; and
generating training triplets by one of adding the foreground object to a background scene using inpainting, or using a model with classifier guidance and a prompt corresponding to the learned object.

16. The non-transitory computer-readable storage medium of claim 15, further comprising generating the plurality of sets of triplets by compositing the training foreground object with the training background scene to create the training composite image via diffusion with classifier guidance that ensures that the training composite image contains a version of the training foreground object and a version of the training background scene.

17. A device comprising:
a processor; and
a storage medium for tangibly storing thereon logic for execution by the processor, the logic comprising instructions for:
training, by the processor, a machine learning model to create composite images from background scenes and foreground objects by providing the machine learning model with a plurality of sets of triplets each comprised of a training background scene, a training foreground object, and a training composite image that combines the training background scene and the training foreground object;
identifying, by the processor, a digital image file that comprises a background scene and an additional digital image file that comprises a foreground object;
compositing, by the machine learning model executed by the processor, the digital image file that comprises the background scene and the additional digital image file that comprises the foreground object to produce a composite digital image file that comprises the foreground object and the background scene by performing at least one of a channel concatenation step and a reverse diffusion sampling step; and
causing display, by the processor, of the composite image file that comprises the foreground object and the background scene.

18. The device of claim 17, wherein identifying, by the processor, the digital image file and the additional digital image file comprises receiving text instructions describing at least one of the foreground object and the background scene.

19. The device of claim 18, further comprising generating, by the machine learning model, at least one of the digital image file and the additional digital image file in response to receiving the text instructions.

20. The device of claim 17, wherein compositing, by the machine learning model executed by the processor, the digital image file and the additional digital image file by performing the channel concatenation step comprises:
adding the foreground object as at least one channel to an intermediate composite image;
adding the background scene as at least one additional channel to the intermediate composite image; and
performing channel concatenation with the intermediate composite image such that a result of the concatenation preserves information from the foreground object, the background scene, and the intermediate composite image.
